(19) United States
(12) Patent Application Publication
(10) Pub. No.: US 2023/0239195 A1
(43) Pub. Date: Jul. 27, 2023

(54) TRANSPARENT HANDLING OF NETWORK DEVICE FAILURES

(71) Applicant: VMware, Inc., Palo Alto, CA (US)

(72) Inventors: Aleksandr V. Mirgorodskiy, San Mateo, CA (US); Arun Kumar Lankalapalli, Santa Clara, CA (US)

(21) Appl. No.: 17/591,096

(22) Filed: Feb. 2, 2022

Related U.S. Application Data
(60) Provisional application No. 63/301,586, filed on Jan. 21, 2022.

(51) Int. Cl. H04L 41/0668; H04L 43/0823; H04L 43/10; H04L 61/103

(52) U.S. Cl. CPC H04L 41/0668; H04L 43/0847; H04L 43/10; H04L 61/103

(57) ABSTRACT

Some embodiments provide a method of addressing failures in a network comprising a computer with at least first and second network interface cards (NICs). The method designates the first and second NICs respectively as primary and secondary NICs of the computer and respectively assigns first and second network addresses to the first and second NICs. The method iteratively sends health monitoring messages to a set of one or more destinations through the first NIC using the first network address. Based on the health monitoring messages, the method detects a potential failure of an element in the network. Based on the detected potential failure, the method redesignates the first and second NICs respectively as secondary and primary NICs and respectively reassigns the first and second network addresses to the second and first NICs. The redesignation accounts for a possibility that the detected potential failure relates to the first NIC.

### BACKGROUND

Network device failures are among the most common problems in modern environments. A network interface controller (NIC) can fail, causing an outage for an individual host. A network switch can fail causing an outage for all hosts connected to it, while a loose network cable can impact an individual host or the entire switch. Network misconfiguration caused by user error can also impact one or many hosts. High-availability systems often rely on redundancy to deal with such component failures. Existing solutions that benefit from redundant network paths have two classes of shortcomings: (1) non-transparency which requires application changes and (2) explicit support and configuration of network switches.

One common technique for using redundant network paths is known as link aggregation (or NIC teaming), a key feature of which is its transparency. Link aggregation hides the existence of multiple NICs and paths from higher layers, letting all network applications benefit from this functionality, and also presents a pair of NICs as a single network interface with a single IP address. Internally, it decides which path to use, thus handling network failures. When both paths are available, it can also achieve higher throughput by utilizing them at the same time. However, link aggregation requires support from network switches, which need to be properly configured to take advantage of this functionality. It complicates system setup and requires extensive testing to ensure that the system as a whole will behave as expected in the face of network failures.

Another common technique is multi-homing, which exposes the existence of multiple NICs to higher layers. A multi-homed system has multiple IP addresses, and network applications are able to choose one or more interfaces for incoming and outgoing traffic. A key advantage is that it requires no explicit support by network switches and no switch configuration. However, each network application needs to detect and handle network failures to benefit from the additional paths.

A third common technique for high-availability systems is the use of a floating IP address. In this situation, each NIC has its own unchanging physical IP address. In addition, a floating IP address “floats” between the different NICs. This solution requires an additional IP address in addition to the physical IP addresses of the NICs.

### BRIEF SUMMARY

Some embodiments provide a novel method of addressing failures in a network that includes a machine (e.g., a bare metal computing device, a host computer, a virtual machine) with multiple network interface controllers or network interface cards (NICs). The method designates first and second NICs respectively as primary and secondary NICs of the machine and respectively assigns first and second network addresses to the first and second NICs (e.g., two network addresses in the same subnet). The method iteratively sends health monitoring messages to one or more destinations through the NICs (e.g., using the first network address for messages sent through the first NIC and the second network address for messages sent through the second NIC). Based on these health monitoring messages, the method detects that connectivity to the destinations through the first NIC has degraded (e.g., due to failure of the first NIC or another element in the network). Thus, the method redesignates the first and second NICs respectively as secondary and primary NICs and respectively reassigns the first and second network addresses to the second and first NICs (e.g., to account for the possibility that the degraded connectivity relates to a failure of the first NIC).

It should be noted that, in some embodiments, the machine includes more than two NICs. In this case, one of the NICs is designated as the primary NIC and assigned the first network address while each of the other NICs is designated as a secondary NIC and assigned different network addresses (all of which may be in the same subnet in some cases). The redesignation operation selects one of the secondary NICs to be redesignated as the primary NIC and reassigns the first network address to this new primary NIC while reassigning to the old primary NIC (now designated as a secondary NIC) the network address previously assigned to the new primary NIC. Other embodiments designate multiple different NICs as primary NICs and each of these NICs is assigned its own primary network address, while the remaining NICs are designated as secondary NICs and assigned secondary network addresses. In this case, if connectivity through any of the primary NICs is degraded, one of the secondary NICs is chosen to replace it using the primary network address of the failed primary NIC.

In some embodiments, the method is performed by a remediation managing module in the machine that maintains a routing table and uses connectivity data for the NICs collected by a path monitoring module. The routing table stores entries for each of the NICs, thereby specifying which of the NICs will be used for outgoing connections from the machine. The first (highest priority) entry in the routing table lists the first network address, and whichever NIC is the primary NIC is mapped to this network address. Any time the primary NIC is changed, the remediation managing module updates the entries of the routing table to map the first network address to the new primary NIC. As such, any processes running on the host can simply use the first network address for outgoing connections and the updated routing table ensures that these are sent via the current primary NIC.

In some embodiments, the remediation manager identifies a likely cause of the failure based on connectivity data for each of the NICs that is collected and updated by the path monitor. The connectivity data, in some embodiments, specifies whether connectivity is available from each NIC to each of the destinations (e.g., destination machines, destination NICs in case other machines also have more than one NIC). In some embodiments, the connectivity data specifies each path from a NIC on the machine to a destination as either available or unavailable, while other embodiments provide additional information regarding the quality of the connections.

The path monitor updates the connectivity data to specify that a path is unavailable based on responses to the health monitoring messages. For instance, if the machine receives an error message in response to attempting to send a health monitoring message to a destination, then the path from the sending NIC to that destination is identified as unavailable. Similarly, if no response is received from a destination (e.g., after a timeout period), then the path from the sending NIC to that destination is identified as unavailable. The machine continues to send health monitoring messages to the destinations after redesignation of the primary and secondary NICs, at this point by using the first network address for messages sent through the second (now primary) NIC and the second network address for messages sent through the first (now secondary) NIC.

The detected unavailability of a path from a NIC to a destination may be caused by an actual failure of a network element along the path. For instance, this unavailability could be caused by a switch to which the NIC connects or a router along the path between the NIC and the destination. The unavailability can also be caused by the failure of the local NIC itself (in which case all paths to all destinations for that NIC will be unavailable) or of a destination NIC (in which case all paths from local NICs to that destination NIC will be unavailable). Irrespective, if the connectivity of the first NIC is identified as worse than the connectivity of the second NIC, then the first NIC will be redesignated as a secondary NIC in favor of the second NIC.

When a machine redesignates primary and secondary NICs, thereby associating different network addresses with the media access control (MAC) addresses of these NICs, some embodiments broadcast messages (e.g., Gratuitous Address Resolution Protocol (GARP) messages) to the local networks of the affected NICs. For instance, when the second NIC is redesignated as the primary NIC and is assigned the first network address, the machine broadcasts a GARP message specifying that the first network address now maps to the MAC address of the second NIC. This enables the local network to direct to the second NIC data messages sent using the first network address (i.e., data messages sent to processes running on the machine).

The preceding Summary is intended to serve as a brief introduction to some embodiments of the invention. It is not meant to be an introduction or overview of all inventive subject matter disclosed in this document. The Detailed Description that follows and the Drawings that are referred to in the Detailed Description will further describe the embodiments described in the Summary as well as other embodiments. Accordingly, to understand all the embodiments described by this document, a full review of the Summary, Detailed Description, the Drawings and the Claims is needed. Moreover, the claimed subject matters are not to be limited by the illustrative details in the Summary, Detailed Description, and Drawings.

### BRIEF DESCRIPTION OF THE DRAWINGS

The novel features of the invention are set forth in the appended claims. However, for purposes of explanation, several embodiments of the invention are set forth in the following figures.

FIG. 1 illustrates an example architecture of some embodiments in which two hosts maintain primary and secondary NICs.

FIG. 2 represents a similar architecture to FIG. 1 but without full mesh connectivity between the NICs of the two hosts.

FIG. 3 illustrates a network with multiple hosts having different numbers of NICs.

FIG. 4 conceptually illustrates a process of some embodiments to monitor and maintain the primary/secondary designation of NICs on a host.

FIG. 5 illustrates example connectivity matrices stored at the hosts shown in FIG. 3.

FIG. 6 illustrates how the designation of the primary and secondary NICs on a host changes when the connectivity status changes for the NICs of that host change.

FIG. 7 illustrates the GARP messages sent from a host as a result of the updates shown in FIG. 6.

FIG. 8 conceptually illustrates an electronic system with which some embodiments of the invention are implemented.

### DETAILED DESCRIPTION

In the following detailed description of the invention, numerous details, examples, and embodiments of the invention are set forth and described. However, it will be clear and apparent to one skilled in the art that the invention is not limited to the embodiments set forth and that the invention may be practiced without some of the specific details and examples discussed.

Some embodiments provide a novel method of addressing failures in a network that includes a machine (e.g., a bare metal computing device, a host computer, a virtual machine) with multiple network interface controllers or network interface cards (NICs). The method designates first and second NICs respectively as primary and secondary NICs of the machine and respectively assigns first and second network addresses to the first and second NICs (e.g., two network addresses in the same subnet). The method iteratively sends health monitoring messages to one or more destinations through the NICs (e.g., using the first network address as the source address for messages sent through the first NIC and the second network address as the source address for messages sent through the second NIC). Based on these health monitoring messages, the method detects that connectivity to the destinations through the first NIC has degraded (e.g., due to failure of the first NIC or another element in the network). Thus, the method redesignates the first and second NICs respectively as secondary and primary NICs and respectively reassigns the first and second network addresses to the second and first NICs (e.g., to account for the possibility that the degraded connectivity relates to a failure of the first NIC).

It should be noted that, in some embodiments, the machine includes more than two NICs. In this case, one of the NICs is designated as the primary NIC and assigned the first network address while each of the other NICs is designated as a secondary NIC and assigned different network addresses (all of which may be in the same subnet in some cases). The redesignation operation selects one of the secondary NICs to be redesignated as the primary NIC and reassigns the first network address to this new primary NIC while reassigning to the old primary NIC (now designated as a secondary NIC) the network address previously assigned to the new primary NIC. Other embodiments designate multiple different NICs as primary NICs and each of these NICs is assigned its own primary network address, while the remaining NICs are designated as secondary NICs and assigned secondary network addresses. In this case, if connectivity through any of the primary NICs is degraded, one of the secondary NICs is chosen to replace it using the primary network address of the failed primary NIC.

In some embodiments, the method is performed by a remediation managing module in the machine that maintains a routing table and uses connectivity data for the NICs collected by a path monitoring module. The routing table stores entries for each of the NICs, thereby specifying which of the NICs will be used for outgoing connections from the machine. The first (highest priority) entry in the routing table lists the first network address, and whichever NIC is the primary NIC is mapped to this network address. Any time the primary NIC is changed, the remediation managing module updates the entries of the routing table to map the first network address to the new primary NIC. As such, any processes running on the host can simply use the first network address for outgoing connections and the updated routing table ensures that these are sent via the current primary NIC.

In some embodiments, the remediation manager identifies a likely cause of the failure based on connectivity data for each of the NICs that is collected and updated by the path monitor. The connectivity data, in some embodiments, specifies whether connectivity is available from each NIC to each of the destinations (e.g., destination machines, destination NICs in case other machines also have more than one NIC). In some embodiments, the connectivity data specifies each path from a NIC on the machine to a destination as either available or unavailable, while other embodiments provide additional information regarding the quality of the connections.

The path monitor updates the connectivity data to specify that a path is unavailable based on responses to the health monitoring messages. For instance, if the machine receives an error message in response to attempting to send a health monitoring message to a destination, then the path from the sending NIC to that destination is identified as unavailable. Similarly, if no response is received from a destination (e.g., after a timeout period), then the path from the sending NIC to that destination is identified as unavailable. The machine continues to send health monitoring messages to the destinations after redesignation of the primary and secondary NICs, in this case by using the first network address for messages sent through the second (now primary) NIC and the second network address for messages sent through the first (now secondary) NIC.

The detected unavailability of a path from a NIC to a destination may be caused by an actual failure of a network element along the path. For instance, this unavailability could be caused by a switch to which the NIC connects or a router along the path between the NIC and the destination. The unavailability can also be caused by the failure of the local NIC itself (in which case all paths to all destinations for that NIC will be unavailable) or of a destination NIC (in which case all paths from local NICs to that destination NIC will be unavailable). Irrespective, if the connectivity of the first NIC is identified as worse than the connectivity of the second NIC, then the first NIC will be redesignated as a secondary NIC in favor of the second NIC. It should be noted that after redesignation of NICs on a source host, a destination host still communicates with the source host using the primary network address assigned to the current primary NIC of the source host, meaning that the destination host is not affected by redesignation of NICs on the source host.

When a machine redesignates primary and secondary NICs, thereby associating different network addresses with the media access control (MAC) addresses of these NICs, some embodiments broadcast messages (e.g., Gratuitous Address Resolution Protocol (GARP) messages) to the local networks of the affected NICs. For instance, when the second NIC is redesignated as the primary NIC and is assigned the first network address, the machine broadcasts a GARP message specifying that the first network address now maps to the MAC address of the second NIC. This enables the local network to direct to the second NIC data messages sent using the first network address (i.e., data messages sent to processes running on the machine).

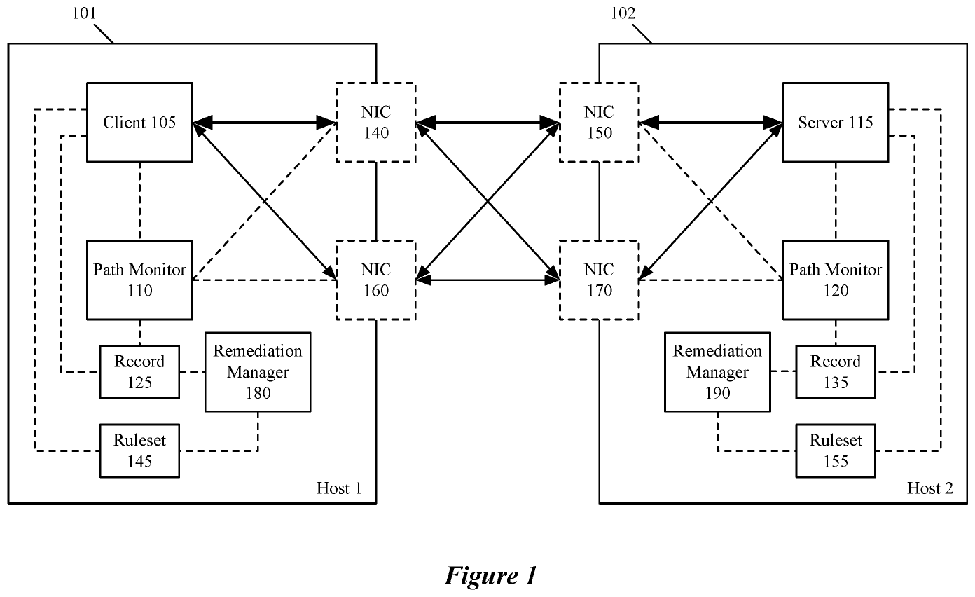

FIG. 1 illustrates an example architecture of some embodiments in which two hosts maintain primary and secondary NICs. A first host 101 executes at least one client 105, a path monitor 110 that maintains a connectivity record 125, and a remediation manager 180 that maintains a ruleset 145. The first host 101 includes two NICs 140 and 160. A second host 102 executes at least one server 115, a path monitor 120 that maintains a connectivity record 135, and a remediation manager 190 that maintains a ruleset 155. The second host 102 also includes its own two NICs 150 and 170. The two hosts 101 and 102 communicate using the NICs 140, 150, 160, and 170. In some embodiments, the architecture of FIG. 1 represents a physical structure, and the NICs are physical NICs (pNICs). In other embodiments, the architecture represents a virtual structure, and the NICs are virtual NICs (vNICs).

In some embodiments, host 101 may forward traffic from either of its NICs 140 and 160, through an intervening network (not shown), and to host 102 through its NICs 150 and 170. In full mesh connectivity, there are four pathways between the hosts 101 and 102: (1) between NIC 140 and NIC 150, (2) between NIC 140 and NIC 170, (3) between NIC 160 and NIC 150, and (4) between NIC 160 and NIC 170. In some embodiments, the network includes one or more routers between the hosts 101 and 102, while in other embodiments both hosts connect to the same local network (e.g., to the same switch). One of ordinary skill would understand that any number and any type of network elements may be placed between hosts. In some embodiments, the hosts are located in the same datacenter, while in other embodiments the network between the hosts spans multiple datacenters.

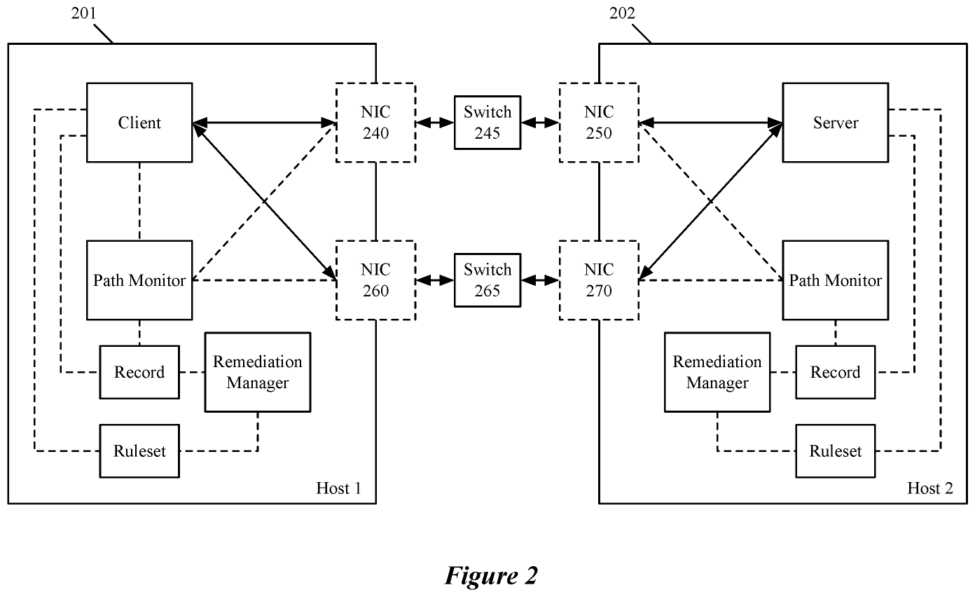

Depending on the network structure between hosts, in some embodiments full mesh connectivity does not exist between the NICs of the hosts. For example, FIG. 2 represents a similar architecture to FIG. 1. In this example, switch 245 connects NIC 240 of host 201 and NIC 250 of host 202 while switch 265 connects NIC 260 of host 201 and NIC 270 of host 202. Because of the switches 245 and 265, there are only two possible pathways: (1) between NIC 240 and NIC 250, and (2) between NIC 260 and NIC 270. Because not all NICs on one host may communicate with all NICs on another host, there is not full mesh connectivity.

Referring back to FIG. 1, each host 101 and 102 executes a path monitor 110 and 120, respectively. It is the responsibility of the path monitor on a particular host to monitor the availability of connectivity between the particular host and any destination hosts (e.g., for all paths between the particular host and any destination hosts). For instance, path monitor 110 may periodically send heartbeat messages (e.g., bidirectional forwarding detection (BFD) messages), also referred to as health monitoring messages, along all possible paths from its host 101 to the other host 102 to monitor the health of those paths. It should be noted that, in this regard, a “path” refers to any path through the network from a NIC on one host to a NIC on another host, irrespective of the network elements through which that path passes. That is, the path monitor monitors the availability of any connection from one endpoint NIC on its host to an endpoint NIC on another host rather than a specific pathway through a specific set of network elements.

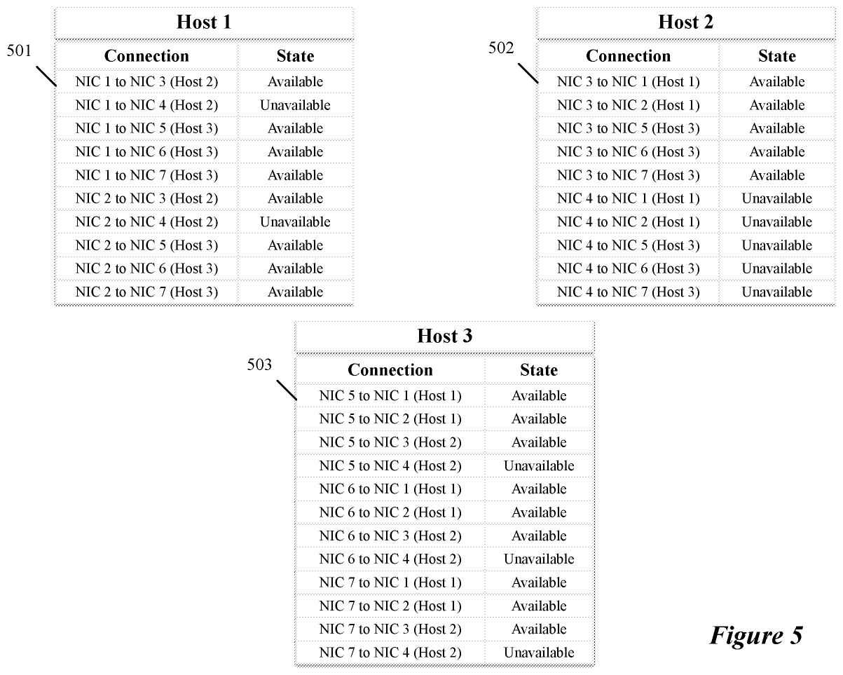

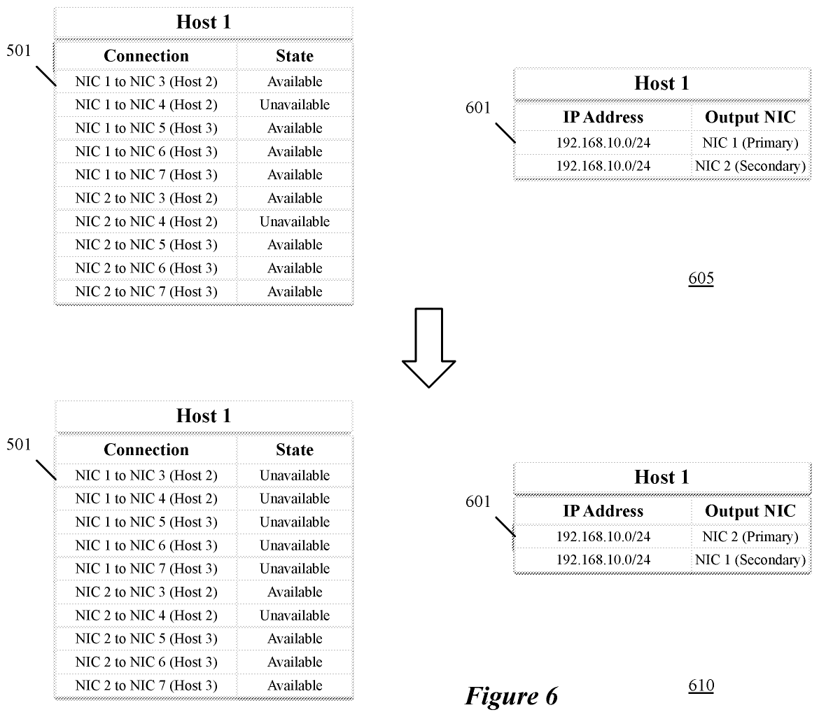

Upon reception of a heartbeat message along a particular path from host 101 (i.e., from a particular one of the NICs 140 and 160 and directed to a particular one of the NICs 150 and 170), the host 102 sends back an echo or reply message to host 101 along the particular path (i.e., directed to the source network address for the heartbeat message). Once host 101 receives the reply from host 102, the path monitor 110 is able to confirm that this particular path is functioning properly. The path monitor 110 may perform its monitoring process for each path between the host 101 and a destination and store connectivity data for each of these paths. The path monitor 110 stores this connectivity data in the connectivity record 125 in order to maintain an up to date record of all of the paths. Further discussion regarding this connectivity data will be described below by reference to FIGS. 5 and 6.

In some embodiments, a remediation manager may use the connectivity data collected by the path monitor to detect a potential failure of a NIC of its host by detecting that one or more paths between the NIC and a destination is no longer available. For example, the path monitor 110 sends heartbeat messages to each NIC 150 and 170 of host 102 through NICs 140 and 160. If the host 101 receives an error message in response to sending out a heartbeat message for a particular path or simply fails to receive a reply from host 102 for a specified period of time (i.e., until a timeout), the path monitor 110 identifies that the particular path over which the heartbeat message was sent has lost connectivity (e.g., because of one or more components along that path). A loss of connectivity may occur because of the source host's NIC, destination host's NIC, or any other network element through which the heartbeat message needs to pass in order to reach the destination.

The path monitor 110 records this data in the connectivity record 125 in order to detect path failures and for the remediation manager 180 to identify likely causes of these failures. The path monitor 120 at host 102 performs similar operations to monitor paths between each of its NICs 150 and 170 and each of its destinations, and stores its own connectivity data for the remediation manager 190. The path monitor is described in more detail in U.S. Pat. No. 10,554,520, which is incorporated herein by reference.

A host of some embodiments may configure its NICs in a high-availability (HA) manner in order to provide for transparent handling of NIC failures on the host. While the following example specifies components of host 101, a similar configuration may be executed on host 102 or another host. On host 101, NIC 140 may be designated as the primary NIC of the host and assigned a primary network address (e.g., Internet Protocol (IP) address). In this case, NIC 160 is designated as the secondary NIC of the host and assigned a secondary network address. With this configuration, the client 105 communicates with the server 115 (and any other destinations) using NIC 140, which is shown with a bold arrow. It should be noted that while the client 105 does not actually determine which NIC of the host 101 it uses to communicate with other hosts, when the NIC 160 is designated as the primary NIC of the host 101, the client 105 uses the NIC 160. This is because the client 105 uses only the primary NIC at any given time (i.e., by sending data traffic using the same primary IP address as the source address), irrespective of which NIC is currently designated as the primary IP address. In some embodiments, host 102 may also designate its NICs 150 and 170 as primary and secondary NICs, respectively. The NICs 150 and 170 advertise this configuration to the network such that when client 105 sends data traffic using the primary IP address of host 2 as a destination address the data traffic is directed to the NIC 150.

Referring back to the host 101, the remediation manager 180 records the primary and secondary designations of the NICs in the ruleset 145. In some embodiments, this ruleset 145 is a routing table used by a network stack of the host 101 to process outgoing network traffic (i.e., thereby routing outgoing traffic sent from the primary network address to the primary NIC). The client process 105 exchanges data messages with host 102 by sending traffic from the primary network address of the host 101 to a network address of the host 102. When the NIC 140 is designated as the primary NIC of host 101, this traffic is sent out via the NIC 140 because the source network address of the traffic maps to that NIC 140. The remediation manager 180 maintains the primary/secondary designation of the NICs 140 and 160 and may update the ruleset 145 each time the designation changes.

If the remediation manager 180 detects that a path from host 101 to host 102 that includes the currently designated primary NIC 140 is not functioning properly (e.g., as detected by the heartbeat messages and recorded in the connectivity record 125 by the path monitor 110), the remediation manager 180 may attribute the faulty path to the NIC 140 and switch the primary and secondary designations of the NICs on host 101. When the remediation manager 180 switches the designation, the NIC 160 is now designated as the primary NIC of the host 101 and the primary network address is reassigned to that NIC 160. The NIC 140 is thus designated as the secondary NIC of the host and assigned the secondary network address. The remediation manager 180 records the updated designation of the NICs in the ruleset 145. After this redesignation, traffic from the client process 105 is sent out via the NIC 160 because the source network address of the traffic maps to that NIC 160.

In some embodiments, the remediation manager 180 may detect that one or more paths from the secondary NIC 160 is not properly functioning. However, in this case, the remediation manager 180 does not need to change the primary/secondary designation of the NICs 140 and 160 because non-optimal connectivity (i.e., one or more faulty paths) for a secondary NIC does not affect packets exchanged between host 101 and 102. Further discussion regarding primary and secondary designation switches and rulesets storing the primary and secondary designations will be described below.

It should be noted that while these examples illustrate hosts with physical NICs, the invention is similarly applicable to virtualized contexts. That is, in some embodiments, the path monitors execute on virtual machines and track connectivity for virtual NICs (vNICs). In addition, the clients and servers shown in these examples could be virtual machines (VMs) or other machines (e.g., containers) executing on virtualization software of the host or simply processes running on a bare metal computing device.

In some embodiments, more than two hosts may communicate with one another and a single host may include more than two NICs. For instance, in some embodiments, the path monitoring and IP address redesignation is used for hosts and storage nodes in a distributed storage network. Either the hosts, storage nodes, or both may include multiple NICs and expect full connectivity between hosts and storage nodes. That is, each host may optimally connect to all of the storage nodes in a storage pool. In this case, each storage node monitors connectivity from each of its NICs to each of the NICs of each host and/or each host monitors connectivity from each of its NICs to each of the NICs of each storage node.

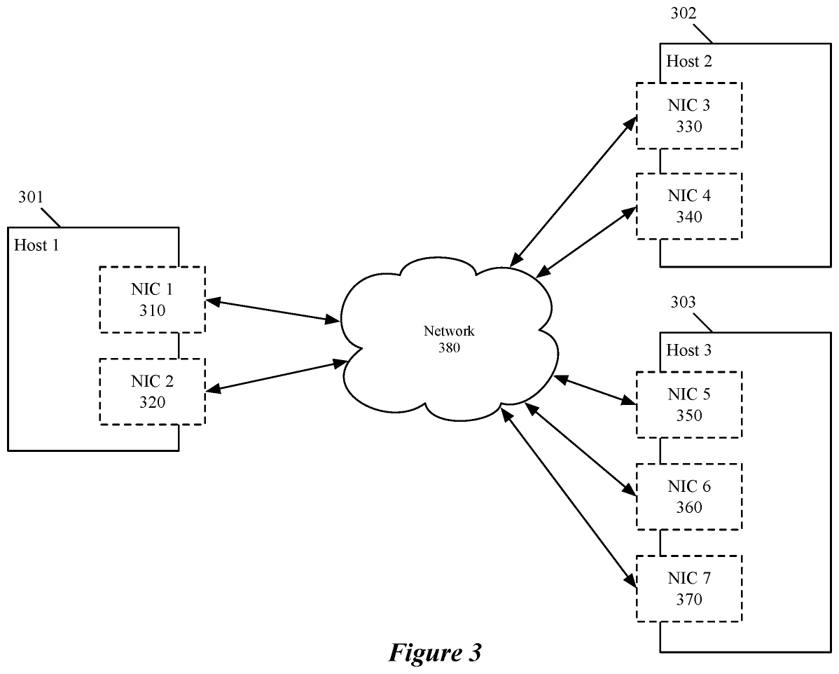

FIG. 3 illustrates a network with multiple hosts having different numbers of NICs. In this example, host 301 includes two NICs 310 and 320, host 302 includes two NICs 330 and 340, and host 303 includes three NICs 350, 360, and 370. Each of the hosts 301, 302, and 303 may communicate with each other through an intervening network 380, and any number and any type of components in the intervening network 380 may be part of a pathway between any of the hosts. Each of the hosts 301, 302, and 303 in some embodiments may include components similar to those described for FIG. 1 that perform similar operations (i.e., a remediation manager storing a routing table record, etc.). In addition, each of the hosts may execute processes that serve as a client or a server for a connection with another host.

Hosts 301 and 302 each include two NICs and configure primary/secondary designations of their NICs similarly to the hosts of FIG. 1. Host 303, however, executes three NICs 350, 360, and 370. In this case, host 303 designates one of its NICs as the primary NIC and assign it a primary IP address and designates all other NICs as secondary NICs and assigns them different secondary IP addresses. If host 303 changes the primary/secondary designation of its NICs because the current primary NIC is part of one or more faulty paths to one or more hosts, host 303 may choose any of its secondary NICs to be designated as the new primary NIC. In some embodiments, this decision may be based on which secondary NIC of host 303 has the best connectivity. For example, if only a first NIC on a host has available connectivity for all of its paths, while all other NICs on the host have at least one unavailable path, then the first NIC has the best connectivity and is designated as the primary NIC.

In some embodiments, if multiple NICs all have available connectivity for all paths, then the remediation manager on the host selects any of these NICs as the primary NIC. If all of the NICs have at least one path unavailable, in some embodiments the remediation manager identifies the NIC with the best overall connectivity to select as the primary NIC. The best overall connectivity may be determined based on the number of paths available or the number of other hosts that can be reached. For instance, some embodiments might determine that a first NIC with connectivity available to one NIC on each potential destination host has better connectivity than a second NIC with connectivity available to a larger absolute number of potential destination NICs but with no connectivity to any NICs on at least one destination host.

The remediation manager of some embodiments employs a conservative strategy to switching the primary and secondary designations once a NIC has been designated as the primary NIC. In this strategy, the remediation manager only changes the designation if one of the secondary NICs has connectivity to a strict superset of the destinations (determined either in terms of destination hosts or destination NICs) to which the primary NIC has connectivity. That is, if a secondary NIC has connectivity to all of the destinations to which the current primary NIC has connectivity in addition to at least one additional destination to which the current primary NIC does not have connectivity, then the remediation manager redesignates the primary and secondary NICs. Otherwise, the host does not modify the NIC designation. A similar strategy is used for storage controller failover purposes in the invention described in U.S. Pat. No. 10,554,520, which is incorporated by reference above.

In some embodiments, all NICs on a single host will be assigned an IP address from the same subnet. However, not all NICs in a system must have IP addresses from the same subnet. For example, NICs 310 and 320 on host 301 may be assigned IP addresses from a first subnet, NICs 330 and 340 on host 302 may be assigned IP addresses from a second subnet, and NICs 350, 360, and 370 on host 303 may be assigned IP addresses from a third subnet.

In some embodiments, the host also uses multi-homing (i.e., multiple NICs with their own separate IP addresses that are exposed to the applications or processes on the host) in addition to the above-described redesignation. In this case, the applications or processes on the host that have the capability to handle the multi-homed NICs can use any of the IP addresses (i.e., primary and any secondary IP addresses) to send data traffic, whereas any legacy applications or processes use only the primary IP address which will be routed via the NIC with the best connectivity. That is, the redesignation process enables legacy applications (e.g., third-party applications) that cannot be configured to use multiple IP addresses to operate on a computer with multiple NICs having different IP addresses and takes advantage of NIC redundancy for fault-tolerance.

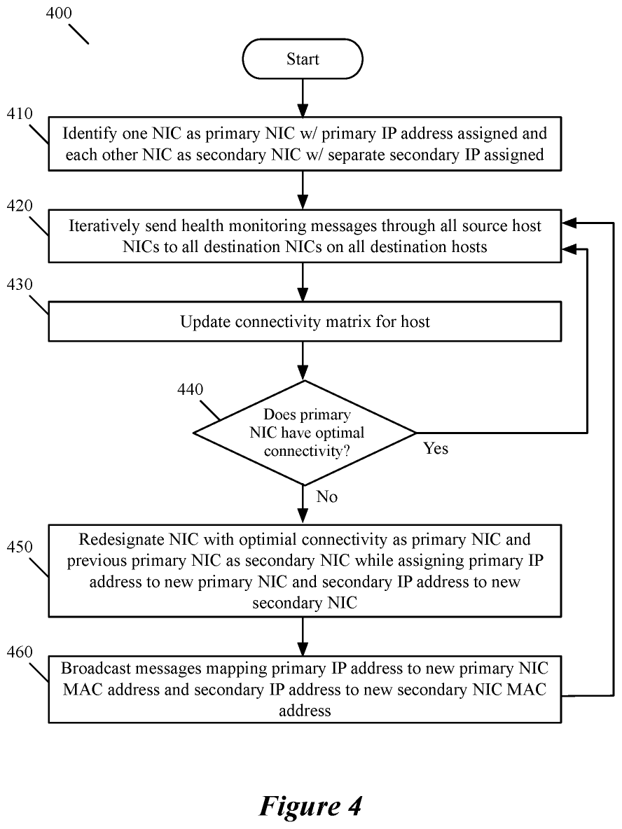

FIG. 4 conceptually illustrates a process 400 of some embodiments to monitor and maintain the primary/secondary designation of NICs on a host. This process 400 is performed at least in part by a remediation manager and/or path monitor executing on the host in some embodiments. The following example will be described with reference to host 301 of FIG. 3, but it should be understood that the process 400 may be performed by any other host with two or more NICs that communicates with one or more hosts.

The process 400 begins by identifying (at 410) one NIC as the primary NIC with a primary IP address assigned and identifying each other NIC as secondary NICs with secondary IP addresses assigned. For instance, a remediation manager executing on host 301 may designate NIC 1 as the primary NIC and assign it a primary IP address while designating NIC 2 as the secondary NIC and assigning it a secondary IP address. With this configuration of the NICs, host 301 may send traffic to hosts 302 and 303 using the primary NIC 1.

The process 400 iteratively sends (at 420) health monitoring messages (e.g., BFD messages) through all source host NICs to all destination NICs on all destination hosts. Host 301 may periodically send heartbeat messages out of both NICs 310 and 320, through the intervening network 380, to all NICs on hosts 302 and 303. The path monitor of host 301 is able to monitor the replies to these heartbeat messages to monitor the health of all pathways from its host 301 to all other hosts 302 and 303.

Next, the process 400 updates (at 430) the connectivity matrix for the host. Once the path monitor of host 301 knows the connectivity of each path from host 301, it is able to update the host's connectivity matrix and store this data in a record. FIG. 5 illustrates example connectivity matrices 501, 502, and 503 stored at hosts 301, 302, and 303, respectively. The connection column lists each possible path of one of its NICs to another NIC on another host, while the second column lists the availability or the state of the path. It should be noted that, in some embodiments, the destinations are listed as IP addresses rather than NICs, because the various other hosts might also switch which NIC is associated with each IP address depending on connectivity. That is, host 1 might send out health monitoring messages to determine connectivity to the primary IP address of host 2 without knowledge of which physical NIC of host 2 this corresponds to at any given time.

For example, the second connection listed in table 501 specifies the path from NIC 1 on host 1 to NIC 4 on host 2, which is listed as unavailable. That is, the heartbeat messages sent from NIC 1 to NIC 4 resulted in an error message or no reply from NIC 4, and therefore that this path is not functioning properly. Many of the other connections listed in table 501 list their respective paths as available, indicating that reply messages are being sent regularly in response to the respective heartbeat messages. It should be noted that, while these examples list each path as either available or unavailable, other embodiments provide additional information about the connectivity that can be used to determine which NIC has the best overall connectivity (e.g., a measurement of the time required to reach each endpoint).

Referring back to FIG. 4, the update of the connectivity matrix only requires any changes to the connectivity matrix when the status of one or more of the paths has actually changed. If the connectivity status has not changed for any of the paths, then the connectivity matrix is not actually modified. On the other hand, if any of the connectivity status changes for any of the paths, then these states are updated in the connectivity matrix.

Next, the process 400 determines (at 440) whether the primary NIC of the host still has optimal connectivity among the various NICs. In some embodiments, the remediation manager of the host may determine that one or more paths that include the currently designated primary NIC is unavailable. In this case, the remediation manager is able to determine that there is a potential failure along the faulty path and may attribute the fault to the primary NIC. For instance, the table 502 indicates that all of the paths from NIC 4 are unavailable. In this case, NIC 4 has likely failed (or its direct connectivity to the network has gone down for another reason, such as a faulty physical connection). Thus, the remediation manager on the host 302 will have designated NIC 3 as the primary NIC with optimal connectivity for this host and assigned the primary network address for the host to NIC 3. If the primary NIC continues to have the optimal connectivity among the NICs on the host, the process 400 returns to 420 to continue iteratively sending health monitoring messages to monitor the connectivity status for the NICs of the host.

When the primary NIC no longer has optimal connectivity among the NICs on the host, the process 400 redesignates (at 450) the NIC that does have optimal connectivity as the primary NIC and the previous primary NIC as the secondary NIC while assigning the primary IP address to the new primary NIC and a secondary IP address to the new secondary NIC. FIG. 6 illustrates, over two stages 605-610, how the designation of the primary and secondary NICs on a host changes when the connectivity status changes for the NICs of that host change. The first stage 605 shows the connectivity matrix 501 for the host 301 in the same state as shown in FIG. 5. In this state, each of NIC 1 and NIC 2 have equivalent connectivity. The routing table 601 maps IP addresses and/or subnet ranges to NICs. At this point, the routing table 601 maps the subnet 192.168.10.0/24 to the primary NIC 1 with a higher priority (i.e., with the first entry in the routing table) and maps this subnet to secondary NIC 2 with a lower priority (i.e., with a later entry in the routing table). As both the primary and secondary IP addresses are in the same subnet, the order of these entries in the routing table determines which interface will be used for outgoing connections initiated by processes on the host. For incoming connections, these processes listen on the primary IP address, and so will successfully receive connections sent to this IP and received at the primary NIC.

The second stage 610 illustrates these tables 501 and 601 after the path monitor updates the connectivity matrix 501 and the remediation manager updates the routing table 601. At this second stage, all of the connections from NIC 1 to any destination have failed and are now marked as unavailable. This may be due to failure of the NIC itself, disconnection of the NIC from the network, or other connectivity failure. Regardless, as a result, the remediation manager on the host 301 has determined that NIC 1 is no longer the optimal NIC as it does not have connectivity to any destination and updates the routing table 601.

In some embodiments, the remediation manager uses the path reachability information from the path monitor to diagnose which element (e.g., local NIC, destination NIC, intervening network element) has failed. For instance, if all connections from a particular local NIC are unavailable, the fault may be attributed to that local NIC. Similarly, if all connections to a particular remote NIC are unavailable, the fault may be attributed to that remote NIC. If all paths to a particular destination host fail, the fault may be attributed to that destination host or the network local to that destination host. If a set of path failures are more random, the fault may be attributed to one or more components in the intervening network.

Thus, the remediation manager on the host 301 redesignates NIC 2 as the primary NIC and assigns the primary IP address 192.168.10.1 to this NIC, while designating NIC 1 as a secondary NIC and assigning the secondary IP address 192.168.10.2 to NIC 310. These changes are reflected in the updated routing table 601, which now maps the primary IP address to NIC 2 and the secondary IP address to NIC 1. The primary IP address remains the highest-priority IP address in the routing table 601 such that outgoing traffic is still sent using the primary IP address but is routed out of the new primary NIC 2 rather than the previous primary NIC 1.

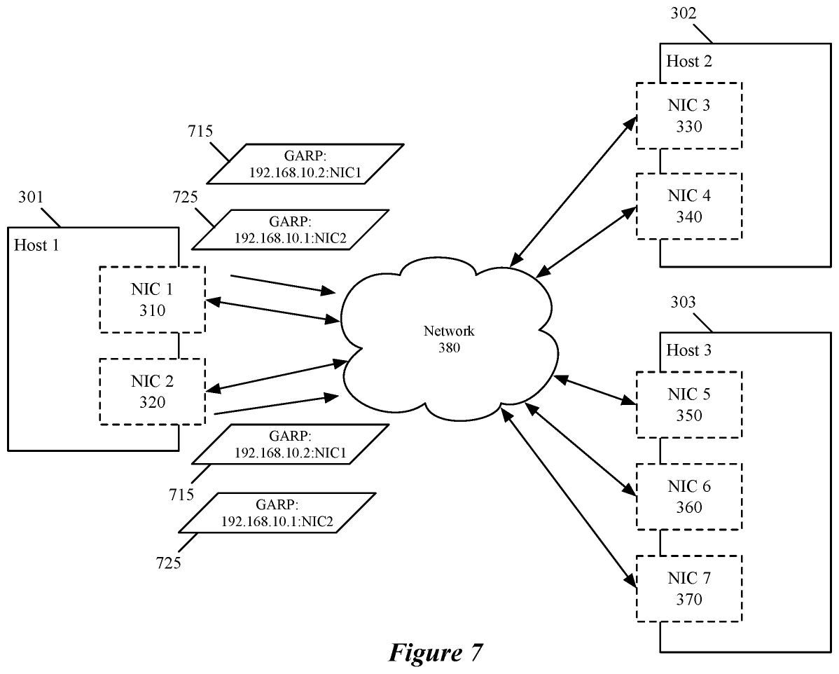

Returning to FIG. 4, the process 400 then broadcasts (at 460) messages mapping the primary IP address to the new primary NIC's MAC address and mapping the secondary IP address to the new secondary NIC's MAC address. In some embodiments, these broadcast messages are GARP messages specifying these new mappings. FIG. 7 illustrates the GARP messages 715 and 725 sent from the host 310 as a result of the updates shown in FIG. 6. In some embodiments, each NIC of the host sends all GARP messages mapping the IP addresses to the NICs. The GARP messages 715 and 725 sent from the new primary NIC 320 specifies (1) that the IP address 192.168.10.2 (i.e., the secondary IP address) now maps to the MAC address for NIC 1 and thus that the local network should therefore resolve that IP address to the MAC address of NIC 1 and send any data traffic for that IP address to NIC 1, and (2) that the IP address 192.168.10.1 (i.e., the primary IP address) now maps to the MAC address for NIC 2 and thus that the local network should therefore resolve that IP address to the MAC address of NIC 2 and send any data traffic for that IP address to NIC 2. Similarly, the GARP messages 715 and 725 are also sent from the new secondary NIC 310. It should be noted that if NIC 1 has failed or completely lost connectivity, the GARP messages 715 and 725 may not actually be sent by NIC 1 or may not actually be able to reach the local network from this NIC. However, because primary NIC 320 sends both GARP messages 715 and 725, all necessary information will be able to reach the local network.

The GARP messages enable any components on the local network (e.g., other hosts, routers, etc.) to update their ARP caches that map IP addresses to MAC addresses. For instance, if either of the hosts 302 or 303 are on the same broadcast network as the first host 301, then these hosts will be able to update their ARP caches so that data messages sent to the primary IP address 192.168.10.1 are sent to the MAC address for NIC 2 320. Similarly, any routers in the network 380 that connect to the same broadcast network as the host 301 can also update their ARP caches with this mapping. This prevents the network from continuing to send data traffic with a destination address of 192.168.10.1 to NIC 1 310 based on old mapping data.

Many of the above-described features and applications are implemented as software processes that are specified as a set of instructions recorded on a computer readable storage medium (also referred to as computer readable medium). When these instructions are executed by one or more processing unit(s) (e.g., one or more processors, cores of processors, or other processing units), they cause the processing unit(s) to perform the actions indicated in the instructions. Examples of computer readable media include, but are not limited to, CD-ROMs, flash drives, RAM chips, hard drives, EPROMs, etc. The computer readable media does not include carrier waves and electronic signals passing wirelessly or over wired connections.

In this specification, the term “software” is meant to include firmware residing in read-only memory or applications stored in magnetic storage, which can be read into memory for processing by a processor. Also, in some embodiments, multiple software inventions can be implemented as sub-parts of a larger program while remaining distinct software inventions. In some embodiments, multiple software inventions can also be implemented as separate programs. Finally, any combination of separate programs that together implement a software invention described here is within the scope of the invention. In some embodiments, the software programs, when installed to operate on one or more electronic systems, define one or more specific machine implementations that execute and perform the operations of the software programs.

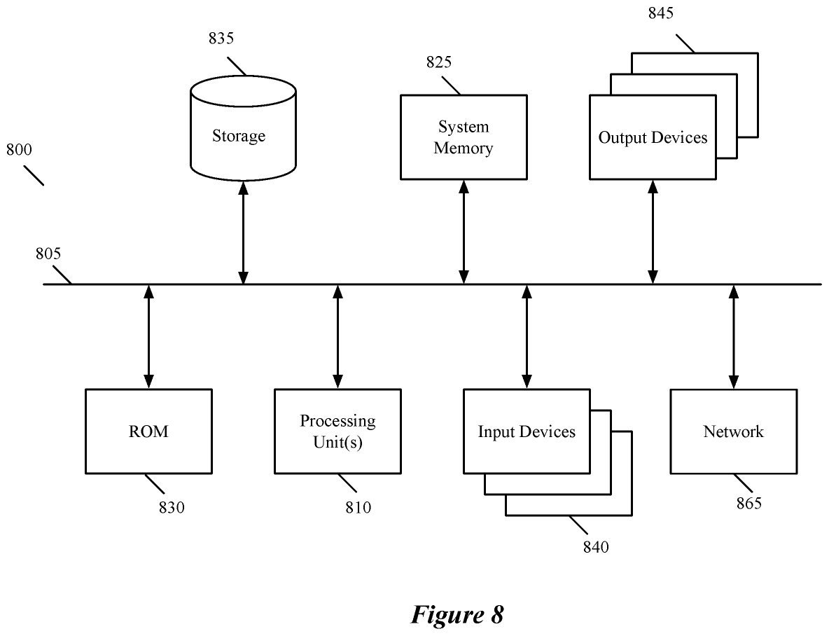

FIG. 8 conceptually illustrates a computer system 800 with which some embodiments of the invention are implemented. The computer system 800 can be used to implement any of the above-described computers and servers. As such, it can be used to execute any of the above described processes. This computer system includes various types of non-transitory machine readable media and interfaces for various other types of machine readable media. Computer system 800 includes a bus 805, processing unit(s) 810, a system memory 825, a read-only memory 830, a permanent storage device 835, input devices 840, and output devices 845.

The bus 805 collectively represents all system, peripheral, and chipset buses that communicatively connect the numerous internal devices of the computer system 800. For instance, the bus 805 communicatively connects the processing unit(s) 810 with the read-only memory 830, the system memory 825, and the permanent storage device 835.

From these various memory units, the processing unit(s) 810 retrieve instructions to execute and data to process in order to execute the processes of the invention. The processing unit(s) may be a single processor or a multi-core processor in different embodiments. The read-only-memory (ROM) 830 stores static data and instructions that are needed by the processing unit(s) 810 and other modules of the computer system. The permanent storage device 835, on the other hand, is a read-and-write memory device. This device is a non-volatile memory unit that stores instructions and data even when the computer system 800 is off. Some embodiments of the invention use a mass-storage device (such as a magnetic or optical disk and its corresponding disk drive) as the permanent storage device 835.

Other embodiments use a removable storage device (such as a flash drive, etc.) as the permanent storage device. Like the permanent storage device 835, the system memory 825 is a read-and-write memory device. However, unlike storage device 835, the system memory is a volatile read-and-write memory, such a random access memory. The system memory stores some of the instructions and data that the processor needs at runtime. In some embodiments, the invention's processes are stored in the system memory 825, the permanent storage device 835, and/or the read-only memory 830. From these various memory units, the processing unit(s) 810 retrieve instructions to execute and data to process in order to execute the processes of some embodiments.

The bus 805 also connects to the input and output devices 840 and 845. The input devices enable the user to communicate information and select commands to the computer system. The input devices 840 include alphanumeric keyboards and pointing devices (also called “cursor control devices”). The output devices 845 display images generated by the computer system. The output devices include printers and display devices, such as cathode ray tubes (CRT) or liquid crystal displays (LCD). Some embodiments include devices such as a touchscreen that function as both input and output devices.

Finally, as shown in FIG. 8, bus 805 also couples computer system 800 to a network 865 through a network adapter (not shown). In this manner, the computer can be a part of a network of computers (such as a local area network (“LAN”), a wide area network (“WAN”), or an Intranet, or a network of networks, such as the Internet. Any or all components of computer system 800 may be used in conjunction with the invention.

Some embodiments include electronic components, such as microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable Blu-Ray® discs, ultra-density optical discs, and any other optical or magnetic media. The computer-readable media may store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the above discussion primarily refers to microprocessor or multi-core processors that execute software, some embodiments are performed by one or more integrated circuits, such as application specific integrated circuits (ASICs) or field programmable gate arrays (FPGAs). In some embodiments, such integrated circuits execute instructions that are stored on the circuit itself.

As used in this specification, the terms “computer”, “server”, “processor”, and “memory” all refer to electronic or other technological devices. These terms exclude people or groups of people. For the purposes of the specification, the terms display or displaying means displaying on an electronic device. As used in this specification, the terms “computer readable medium,” “computer readable media,” and “machine readable medium” are entirely restricted to tangible, physical objects that store information in a form that is readable by a computer. These terms exclude any wireless signals, wired download signals, and any other ephemeral or transitory signals.

While the invention has been described with reference to numerous specific details, one of ordinary skill in the art will recognize that the invention can be embodied in other specific forms without departing from the spirit of the invention. Thus, one of ordinary skill in the art would understand that the invention is not to be limited by the foregoing illustrative details, but rather is to be defined by the appended claims.

1. A method of addressing failures in a network comprising a computer with at least first and second network interface cards (NICs), the method comprising:
designating the first and second NICs respectively as primary and secondary NICs of the computer and respectively assigning first and second network addresses to the first and second NICs;
iteratively sending health monitoring messages to a set of one or more destinations through the first NIC using the first network address;
based on the health monitoring messages, detecting a potential failure of an element in the network; and
based on the detected potential failure, redesignating the first and second NICs respectively as secondary and primary NICs and respectively reassigning the first and second network addresses to the second and first NICs, said redesignation accounting for a possibility that the detected potential failure relates to the first NIC.

2. The method of claim 1, wherein detecting the potential failure comprises receiving an error message when sending a particular health monitoring message to a particular destination through the first NIC.

3. The method of claim 1, wherein detecting the potential failure comprises failing to receive a response from a particular destination to a particular health monitoring message sent through the first NIC.

4. The method of claim 1 further comprising broadcasting the reassignment of the first and second network addresses as a set of Gratuitous Address Resolution Protocol (GARP) messages from at least the second NIC.

5. The method of claim 4, wherein broadcasting the reassignment comprises broadcasting the GARP messages from both the first NIC and the second NIC.

6. The method of claim 1 further comprising, after redesignation, iteratively sending health monitoring messages to the set of destinations through the second NIC using the first network address.

7. The method of claim 6 further comprising:
before redesignation, iteratively sending health monitoring messages to the set of destinations through the second NIC using the second network address; and
after redesignation, iteratively sending health monitoring messages to the set of destinations through the first NIC using the second network address.

8. The method of claim 1, wherein designating the second NIC as the secondary NIC of the computer comprises:
designating a plurality of NICs, including the second NIC, as secondary NICs of the computer; and
assigning a plurality of network addresses not including the first network address to the plurality of NICs.

9. The method of claim 8, wherein redesignating the second NIC as the primary NIC comprises redesignating a particular NIC in the plurality of NICs as the primary NIC and reassigning the first network address to the particular NIC.

10. The method of claim 1, wherein the first and second network addresses belong to a same subnet.

11. The method of claim 1 further comprising storing a routing table comprising a list of the first and second NICs and their assigned network addresses.

12. The method of claim 11, wherein:
a first entry of the routing table lists the primary NIC and the first network address and a second entry of the routing table lists the secondary NIC and the second network address; and
the routing table is updated after redesignating the first and second NICs.

13. The method of claim 1, wherein detecting a potential failure comprises detecting a failure of the first NIC.

14. The method of claim 1, wherein detecting a potential failure comprises detecting a failure of a network element to which the first NIC connects.

15. The method of claim 1 further comprising:
iteratively sending health monitoring messages to the set of destinations through the second NIC using the second network address; and
storing connectivity data identifying connectivity from each of the first and second NICs to each of the destinations.

16. The method of claim 15, wherein detecting the potential failure comprises determining that the connectivity data indicates that the second NIC has better overall connectivity to the set of destinations than the first NIC.

17. The method of claim 1, wherein:
a process executing on the computer sends a first data message using the first network address as a source address prior to the redesignation, the first data message being sent via the first NIC; and
the process sends a second data message using the first network address as a source address after the redesignation, the second data message being sent via the second NIC,
wherein the process executes a same routine to send the first and second data messages without requiring modification to use the different NICs.

18. A non-transitory machine-readable medium storing a program which when executed by at least one processing unit addresses failures in a network comprising a computer with at least first and second network interface cards (NICs), the program comprising sets of instructions for:
designating the first and second NICs respectively as primary and secondary NICs of the computer and respectively assigning first and second network addresses to the first and second NICs;
iteratively sending health monitoring messages to a set of one or more destinations through the first NIC using the first network address;
based on the health monitoring messages, detecting a potential failure of an element in the network; and
based on the detected potential failure, redesignating the first and second NICs respectively as secondary and primary NICs and respectively reassigning the first and second network addresses to the second and first NICs, said redesignation accounting for a possibility that the detected potential failure relates to the first NIC.

19. The non-transitory machine-readable medium of claim 18, wherein the program further comprises a set of instructions for broadcasting the reassignment of the first and second network addresses as a set of Gratuitous Address Resolution Protocol (GARP) messages from the first NIC and the second NIC.

20. The non-transitory machine-readable medium of claim 18, wherein the program further comprises a set of instructions for, after redesignation, iteratively sending health monitoring messages to the set of destinations through the second NIC using the first network address.

21. The non-transitory machine-readable medium of claim 20, wherein the program further comprises sets of instructions for:
before redesignation, iteratively sending health monitoring messages to the set of destinations through the second NIC using the second network address; and
after redesignation, iteratively sending health monitoring messages to the set of destinations through the first NIC using the second network address.

22. The non-transitory machine-readable medium of claim 18, wherein the program further comprises sets of instructions for:
iteratively sending health monitoring messages to the set of destinations through the second NIC using the second network address; and
storing connectivity data identifying connectivity from each of the first and second NICs to each of the destinations.

23. The non-transitory machine-readable medium of claim 22, wherein the set of instructions for detecting the potential failure comprises a set of instructions for determining that the connectivity data indicates that the second NIC has better overall connectivity to the set of destinations than the first NIC.

24. The non-transitory machine-readable medium of claim 18, wherein:
a process executing on the computer sends a first data message using the first network address as a source address prior to the redesignation, the first data message being sent via the first NIC; and
the process sends a second data message using the first network address as a source address after the redesignation, the second data message being sent via the second NIC.
